(19) United States
(12) Patent Application Publication
(10) Pub. No.: US 2012/0014796 A1
(43) Pub. Date: Jan. 19, 2012

(54) KITE FAN BLADE

(76) Inventor: Thomas Cartwright, Stuart, FL (US)

(21) Appl. No.: 13/104,276

(22) Filed: May 10, 2011

Related U.S. Application Data
(63) Continuation-in-part of application No. 11/944,021, filed on Nov. 21, 2007.
(60) Provisional application No. 60/866,907, filed on Nov. 22, 2006.

(51) Int. Cl. F04D 29/38; B23P 11/00

(52) U.S. Cl. 416/142; 29/889.3

(57) ABSTRACT

A fan blade for a ceiling fan includes a blade member and a support for the blade member. The blade member and the support are disassembled in a first mode to occupy a compact space for storage and transport and are assembled in a second mode to form a substantially rigid fan blade for assembly into a ceiling fan.

### CROSS-REFERENCE TO RELATED APPLICATIONS

This application is a continuation-in-part of co-pending U.S. application Ser. No. 11/944,021, filed Nov. 21, 2007, which claims the benefit of priority from U.S. Provisional Patent Application Ser. No. 60/866,907, filed Nov. 22, 2006. The disclosure of each of the aforementioned documents is hereby incorporated by reference.

### FIELD OF THE INVENTION

This invention relates in general to ceiling fans and more particularly to a collapsible fan blade for a ceiling fan.

### BACKGROUND OF THE INVENTION

Ceiling fans are popular commercial and consumer items. They move air in a room to more evenly distribute the air and keep the room at a more constant temperature. Ceiling fans are often used to cool people by providing a stream of air over their bodies. The air stream enhances body cooling by evaporating any surface body moisture and by removing heat from the surface of the skin.

Ceiling fans generally include a plurality of fan blades attached to and arrayed circumferentially around a blade hub. The blade hub is mounted to a motor contained in a motor housing which is supported by a down rod affixed to a ceiling. The fan blade is rigid in structure to resist the dynamic forces generated while being rotated. Further, most manufacturers prefer to sell a fan blade that is fully assembled and only requires attachment to a blade hub. A rigid fan blade is bulky and when combined in a set with other fan blades takes up an undesirable amount of space when stored or transported. It would be desirable to provide fan blades for a ceiling fan which are more compact and amenable to assembly by a user.

There is thus a need for a fan blade for a ceiling fan that is compact for storage and transport, that can be easily assembled to a ceiling fan by a user, and that is rigid when assembled to resist the dynamic forces generated during fan operation.

In some instances, a ceiling fan may be installed in a location that is exposed to outdoor weather conditions, such as in a pavilion. Alternatively, an outdoor overhead fan may be installed on a tall pole extending through a table in a similar fashion to a patio umbrella. In these situations, storm systems with strong winds or precipitation may cause significant damage to the fan or knock it over, especially if the blades are not removed before the storm approaches. The wind and precipitation of the storm may do more damage to the fan and its support structure due to the airfoil effect and surface area of the blades than if the blades were removed. However, the blades are not easily removed in conventional fans, and there may not be time to remove the blades before a storm approaches.

It is therefore desirable to provide fan blades that may be quickly reduced in surface area or removed from the fan.

### SUMMARY OF THE INVENTION

The invention comprises, in one form thereof, a fan blade for a ceiling fan with a flexible blade member and a support structure. The support structure may be modified in order to collapse the flexible blade member. The fan blade may thus be transported or sold to a consumer in a compact form, and the consumer may then assemble the fan blade into a useable form.

More particularly, the invention includes a fan blade for a ceiling fan comprising a blade member; and a support for the blade member having a first rod member, a second rod member, and a mount. Each of the rod members are pivotally connected to the mount at one end. Further the blade member and the support are disassembled in a first mode to occupy a compact space and are assembled in a second mode to form a substantially rigid fan blade for assembly into a ceiling fan.

In another form, the invention includes a collapsible fan blade, comprising a flexible blade member having a curved side and a substantially straight side; a sleeve contiguous with the curved side; and a bendable rod partially inserted into an open end of the sleeve. The bendable rod has a free end and is biased to a straight position.

In another form, the invention includes a method for providing a fan blade. The method comprises the steps of providing a fan blade having a support and a flexible blade member, the fan blade having a compact, unassembled form and a usable form; and providing the fan blade to an end user in the compact, unassembled form.

An advantage of the present invention is that the fan blade is collapsible to occupy a compact space for storage and transport, or to reduce the surface area of the fan to reduce the effect of a storm on the fan. Another advantage is that the fan blade can be easily assembled to a ceiling fan by the user. Further, the fan blade is substantially rigid when assembled to resist the dynamic forces generated during fan operation. A further advantage is that, because the fan blade may be assembled by the end user, the user may be given optional modular parts to use with the fan blade (i.e., additional support members or foil fan blades).

### BRIEF DESCRIPTION OF THE DRAWINGS

The present invention is disclosed with reference to the accompanying drawings, wherein:

FIG. 1 is a perspective view of a ceiling fan incorporating the present invention;

FIGS. 2 and 3 are diagrammatic views showing an embodiment of the present invention;

FIG. 4 is a diagrammatic showing another embodiment of the present invention;

FIG. 5 is a diagrammatic showing a further embodiment of the present invention;

FIG. 6 is an isometric view of the blade hub and blades of a ceiling fan according to an even further embodiment of the present invention;

FIG. 7 is a side view of the blade of FIG. 6 in the collapsed position;

FIG. 8 is a side view of the blade of FIG. 6 in the expanded position;

FIG. 9 is an enlarged view of the base of the Blade of FIG. 8;

FIGS. 10A and 11 are perspective views of a segmented support rod of the present invention;

FIGS. 10B-10D show the assembly of the embodiment of FIG. 10A

FIGS. 12A, a2B show views of a telescoping support rod of the present invention;

FIGS. 13A-13C show a blade with parallel telescoping rods;

FIG. 14 shows a single telescoping rod;

FIG. 15 shows an embodiment with three parallel folding segments;

FIG. 16 shows the folded side view of the embodiment of FIG. 15.

Corresponding reference characters indicate corresponding parts throughout the several views. The examples set out herein illustrate several embodiments of the invention but should not be construed as limiting the scope of the invention in any manner.

### DETAILED DESCRIPTION OF THE PREFERRED EMBODIMENT

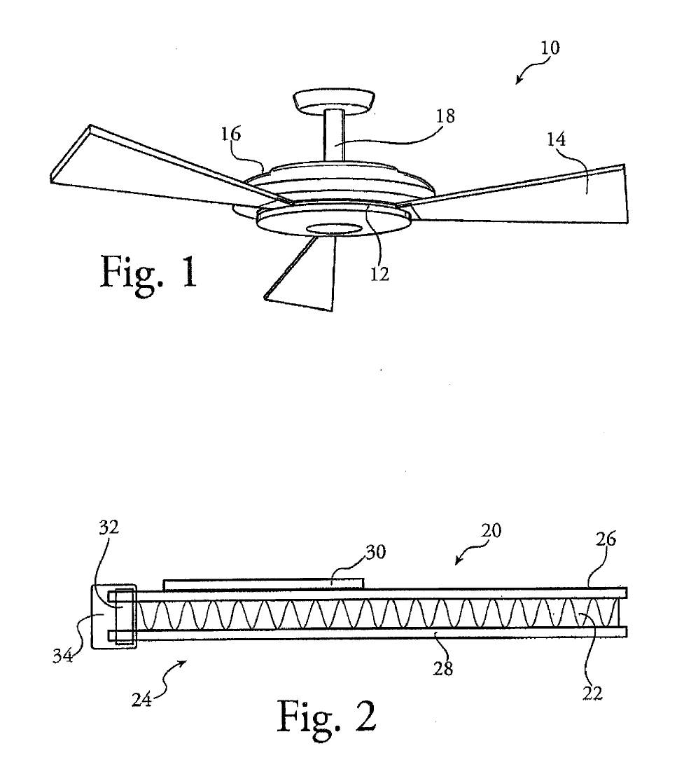

Referring now to FIG. 1, there is shown a ceiling fan incorporating an embodiment of the present invention. As shown, ceiling fan 10 includes a plurality of fan blades 14 circumferentially arrayed about and attached to a blade hub 12. The blade hub 12 is mounted to a motor contained in a motor housing 16 supported by down rod 18.

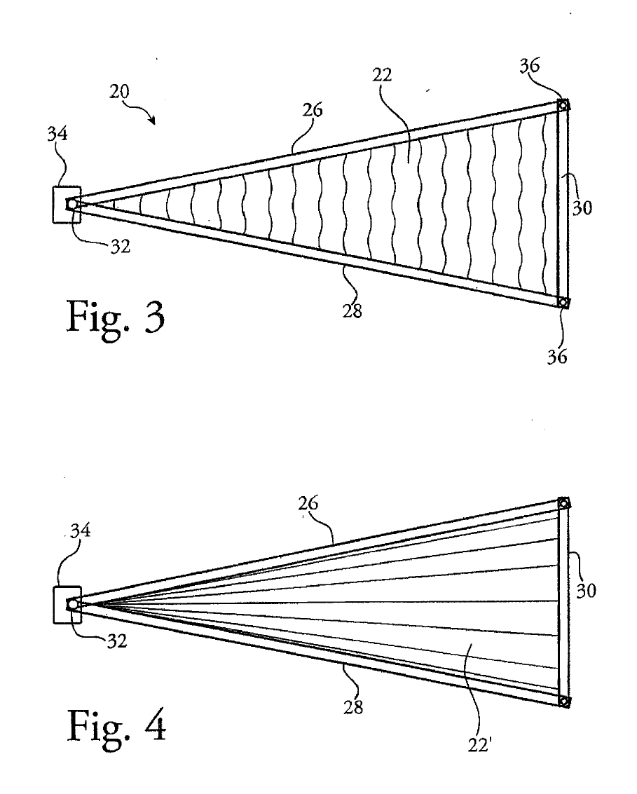

FIGS. 2 and 3 show an embodiment of the present invention. As shown, fan blade 20 includes a blade member 22 of flexible material, such as plastic or fabric, and a support 24. The blade member 22 may have graphics, text, or both printed thereon to display a logo or advertisement, for example. Further, the blade member 22 may be coordinated with the decor in the room containing the fan. Support 24 includes first and second rod members 26 and 28, to which blade member 22 is attached, and third spreader rod member 30. The rod members 26 and 28 and the spreader rod member 30 may be dowels or low-profile boards made of wood, plastic, metal, or another substantially rigid material. The blade member 22 may be attached to the rod members 26 and 28 by adhesive, rivets, welding, or other suitable fastening methods. The rod members 26 and 28 are pivotally connected at one end by pivot 32 mounted in mount 34.

As shown in FIG. 2, fan bade 20 is disassembled in a first mode and occupies a compact space for storage and transport. Rod members 26 and 28 are positioned adjacent to each other, and flexible blade member 22 is collapsed, folded, or gathered between the rod members. Spreader rod member 30 is separate from rod members 26 and 28 and positioned adjacent to them. A clasp or slot may be included with rod member 26 or 28 for storing the spreader rod member 30 in the first mode.

As shown in FIG. 3, fan blade 20 is assembled in a second mode. Rod members 26 and 28 have been spread open and flexible blade member 22 made taut and rigid for use. Spreader rod member 30 is attached to the other ends of rod members 26 and 28 to maintain the tautness of blade member 22 and the rigidity of fan blade 20 so that it can resist the dynamic forces generated during fan operation. The spreader rod member 30 may be attached to the rod members 26 and 28 by inserting the ends of the spreader rod member 30 into sockets 36 provided in the ends of rod members 26 and 28. The spreader rod member 30 has sufficient length such that the tension of the blade member 22 forces the rod members 26 and 28 against the spreader rod member 30 to maintain the spreader rod member 30 in the sockets 36. Alternatively, the spreader rod member 30 may be affixed to the ends of the rod members 26 and 28 by fasteners, adhesive, welding, or other suitable means.

The fan blade is thus easily assembled and may be assembled into a ceiling fan by mounting mount 34 to blade hub 14 (FIG. 1).

It should be noted that the rod members 26 and 28 may be attached to the mount 34 by a common pivot 32 (FIG. 3) or by spaced-apart pivots 32 (FIG. 2). The space-apart pivots provide space for the fabric between the rod members 26 and 28 in the first mode (FIG. 2).

FIG. 4 shows another embodiment of the fan blade of the present invention. The blade member 22′ is pleated, as in a hand fan, to facilitate closing and opening of flexible blade member 22′.

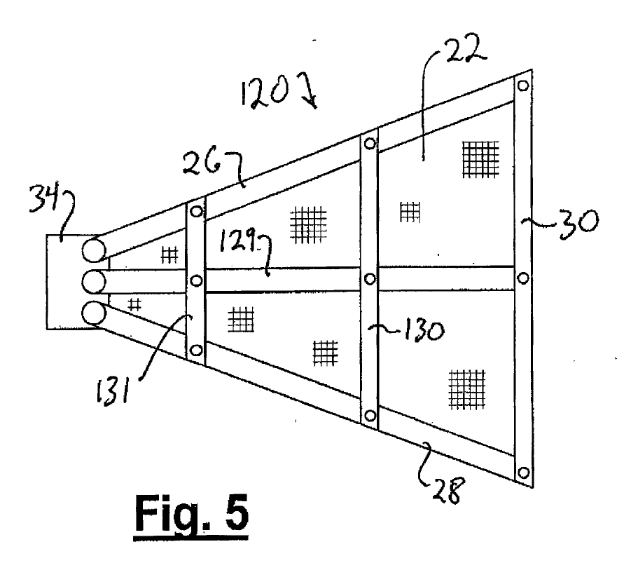

While FIGS. 2-4 show fan blades having only two rod members, 26 and 28, and one spreader rod member 30, a plurality of rod members and spreader rod members may be used in the fan blade. An embodiment showing the fan blade with additional members is shown in FIG. 5. The fan blade 120 includes outer rod members 26 and 28 and an inner rod member 129 for additional support. The inner rod member 129 is connected between the mount 34 and, when assembled in the second mode, the spreader rod member 30. Further, additional rod members 130 and 131 are included to maintain the tension along the length of the blade member 22. The additional spreader rod members 130 and 131 are attached to two or more of the rod members 26, 28, and 129 when the fan blade is in the second mode.

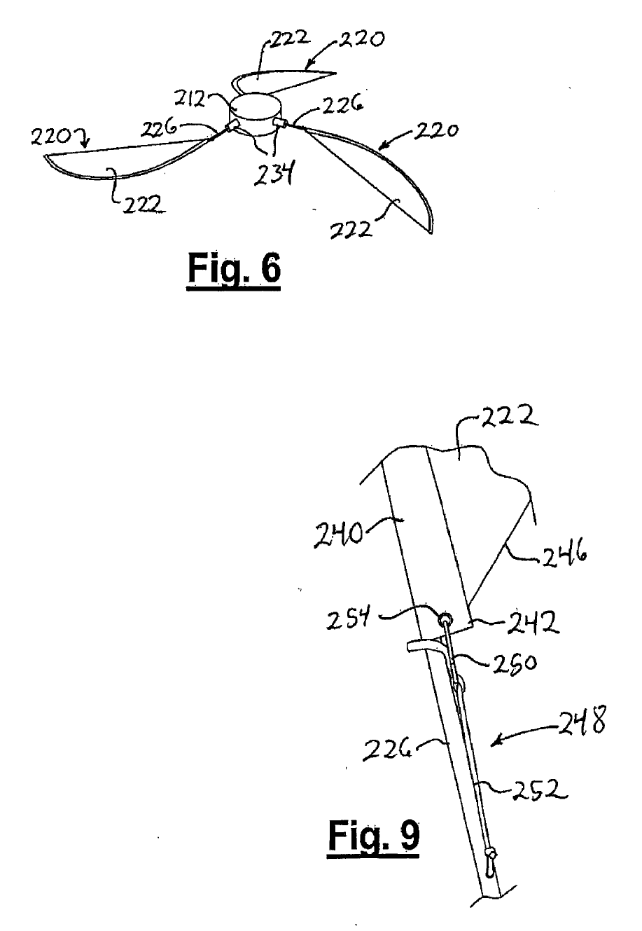

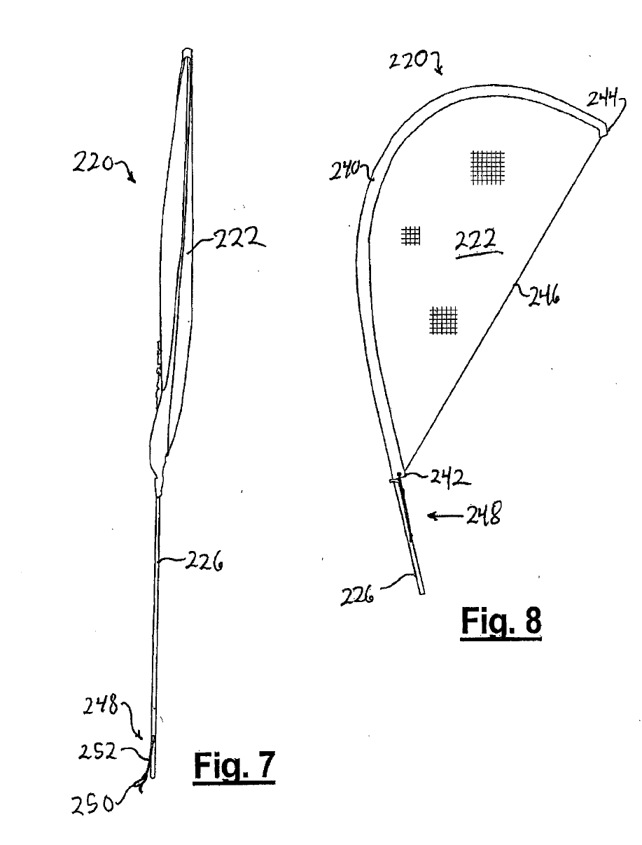

In a further embodiment shown in FIG. 6, the fan blades 220 include a bendable rod 226 and a blade member 222. In FIG. 6, the fan blades 220 are affixed to the hub 212 by a coupler 234. The bendable rod 226 is biased to its straight position (FIG. 7) with a spring constant that will allow an average person to bend the rod, but stiff enough to maintain the blade member 222 in relatively high tension in the second mode described below. The blade member 222 is a flexible material, such as plastic or fabric, and may include graphics, text, or both printed thereon to display a logo or advertisement, for example. Further, the blade member 222 may be coordinated with the decor of the surrounding structure or furniture.

The fan blade 220 is shown as collapsed in the first mode in FIG. 7, and as assembled in the second mode in FIG. 8. The blade portion 222 engages the bendable rod 226 via a sleeve 240 that includes an open end 242 and a closed end 244. The closed end 244 may be affixed to the end of the bendable rod 226 by a screw, a rivet, adhesive, welding, or other suitable methods. Alternatively, the sleeve may be left to slide freely on the bendable rod 226. The sleeve 240 is curved into the desired shape of the blade, and the opposite side 246 of the blade member 222 is substantially shorter than the sleeve 240. This gives the assembled fan blade 220 the shape shown in FIG. 8 with the blade member 222 in tension due to the bias of the bendable rod 226 to the straight position. However, other shapes may be imagined and are considered within the scope of the invention.

The fan blade 220 is maintained in the second mode against the bias of the bendable rod 226 by a fastener 248. Best shown in FIG. 9, the fastener 248 includes a hook 250 and a band 252. The band 252 is preferably flexible and inelastic, such as a string; however, the band may alternatively be elastic or inflexible. The band 252 is attached to the bendable rod 226 at one end and to the hook 252 at the other end by tying to a through hole or by another suitable means. In the second mode, the hook 252 engages a grommet 254 near the open end 242 of the sleeve 240.

In use, the fan blade 220 is affixed to the hub 212 by the coupler 234 and assembled into the second mode. In weather conditions having high wind or precipitation, the surface area of the blades 220 may be quickly reduced by releasing the fastener 248, allowing the bendable rod 226 to straighten and collapsing the blade member 222. The first mode is also advantageous for storage and transport of the blade 220.

In any of the above-described embodiments, the mount 34 or 234 may be a quick coupler. For example, a quick coupler may include a spring-loaded clasp that engages a hole or a notch in the bendable rod 226. A button on the quick coupler forces the clasp against the spring to release the rod.

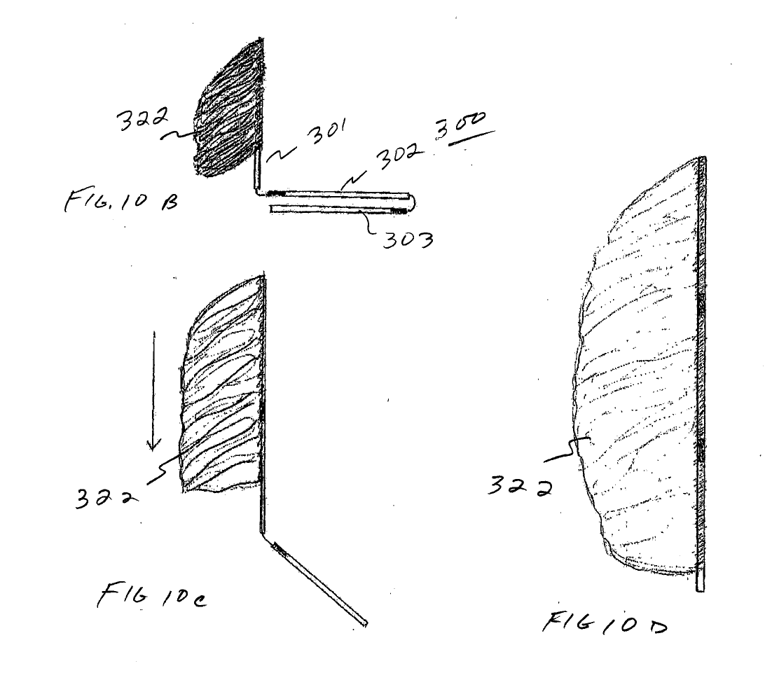

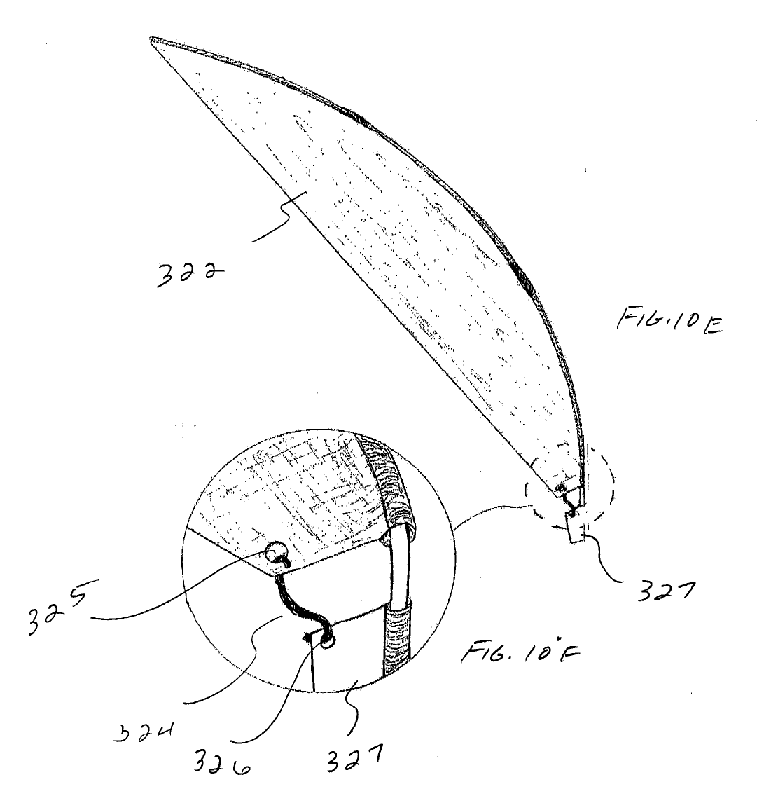

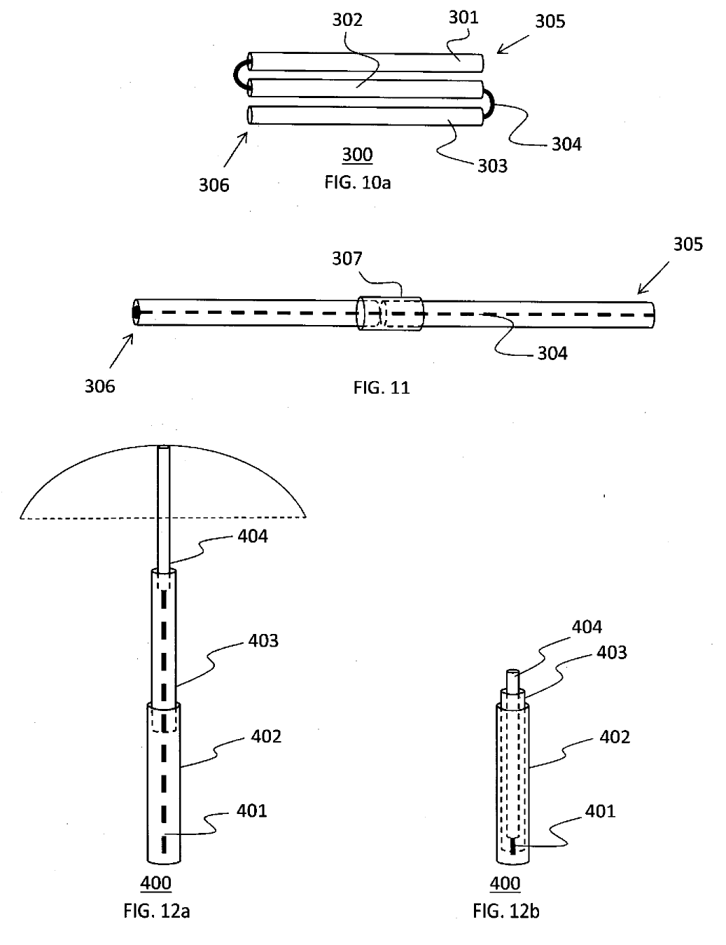

Turning to another embodiment as shown in FIGS. 10A, 11, structural supporting members in the fan blade may include set 300 of hollow, tubular rods 301, 302, 303 of plastic, fiberglass, metal or other flexible material that has an elastic cord 304 inserted inside the hollow rod. The rods, even when segmented (multiple rods), are permanently joined together by the common elastic cord running through each one. The elastic cord 304 is attached to opposite the distal ends 305, 306 of the first 301 and last rod 303. When the rods are assembled, the cord 304 stretches and comes under tension inside the rods, causing the rods to pull themselves into a straight linear shape. This alignment can be facilitated by attaching an additional connector 307 on the end(s) of the rods to help hold the rods as they come into alignment. See FIG. 11. By using this method the collapsed fan blade can be transported and reassembled more easily. The fan blade for the embodiment of FIG. 10A may use the same fabric blade as the one shown in FIG. 8.

A feature of the fan blade 300 is it's convenient size for storage shipping. See for example the sequence of assembly steps in FIG. 10 B-10 F. The fabric fan blade 322 has a sleeve 321 that is bunched around the top segment 301. As the segments 301, 302, 303 are aligned, the blade 322 is slipped down and extended along the length of the connected segments 301-303 until the blade is fully assembled as shown in FIG. 10D. A fan boss 327 is fixed to the bottom segment 303. The fan boss 327 has an opening 326. The fan blade 322 as another opening 325 proximate the fan boss. The opening 325 may be reinforced by surrounding grommet, not shown. A tension connector 324 extends between the openings 325 and 326 to hold the fabric fan blade 322 into tension and connected to the fan boss 327.

Another embodiment 400 with collapsing structural support rods 401, 402, 403 have a telescoping rod that is segmented and extended similar to an umbrella pole being collapsed and extended. See FIG. 12a. The rods, when extended out, are also under tension by an internal spring mechanism 401, to retract back into their original telescope position. The fan blade for the embodiment of FIG. 11 may use the same fabric blade as the one shown in FIG. 8.

A further embodiment 500 has parallel, telescoping rod members 501, 502. Each rod has three segments. In the folding version, the segments are connected together internally by an elastic cord (not shown) in a manner similar to the connection shown in FIG. 10. The cross piece 503 has a central ferrule or connection ferrule (not shown) which is set in place when the fabric is installed over the rods. The fabric is in the form of a sleeve which covers the crosspiece 503 and the rods 501,502. During assembly, the top ribs are not in the ferrule to permit the assembler to slip the fabric sleeve over the rods. Once the fabric is installed on to the rods, the top ribs are inserted into the ferrule at the apex of the structure. The fabric comes under tension. The fabric may be elastic or at least flexible to that it collapses with the telescoping rods. The fabric has elastic straps that connect to the boss to maintain tension in the fabric. In use, the boss 504 at one end of the blade is attached to the motor, the fabric is manipulated over the length of the rods, and the central ferrule on the crosspiece 503 is set.

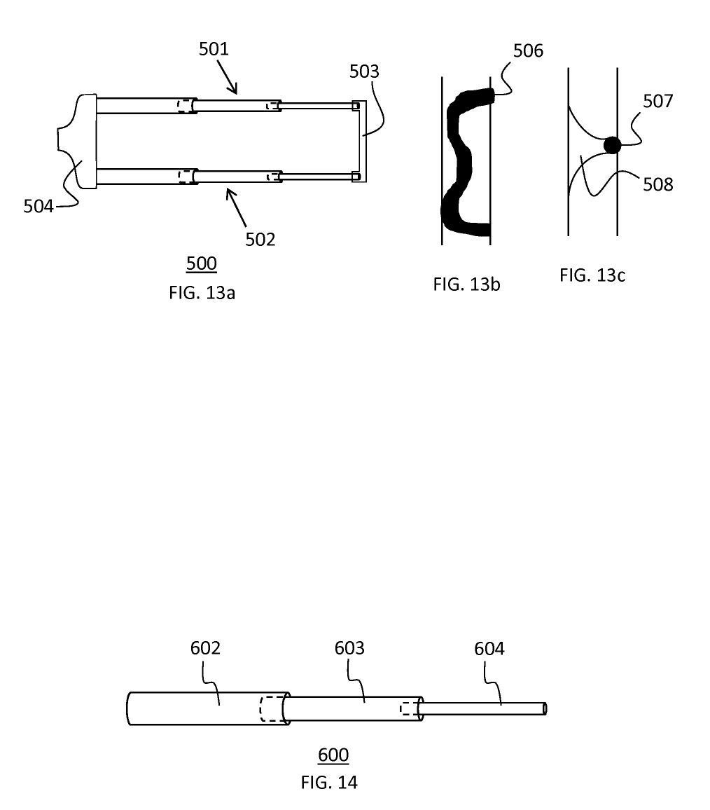

An alternate embodiment for the fan blade of FIG. 13a is a pair of rod members that collapse or telescope into each other. The rods comprise one or more sections of elongated, nested tubular structures which are locked in place by means of a ball detent 509 or simple spring mechanism 506, similar to the ones used on an umbrella pole or extendable suit case handle. See FIGS. 13b,c. A fabric may be fixed between the two telescoping rod members. When the flan blade is collapsed, the fabric folds into the space between the joint connector and the boss for fitting onto the fan motor.

Still another way to lengthen the rod members is to provide a series of nested rods in the form of a pole 600. See FIG. 14. A base rod 602 ends in a hollow ferrule. The second rod 603 inserts into the hollow ferrule at the end of the base rod 602 and terminates in a second hollow ferrule. The third rod 604 inserts into the hollow ferrule at the end of the second rod 603 and terminates in a closed ferrule. The rods may be made of flexible material such as fiberglass. The fan blade for the embodiment with the nested rods may use the same blade as the one shown in FIG. 8.

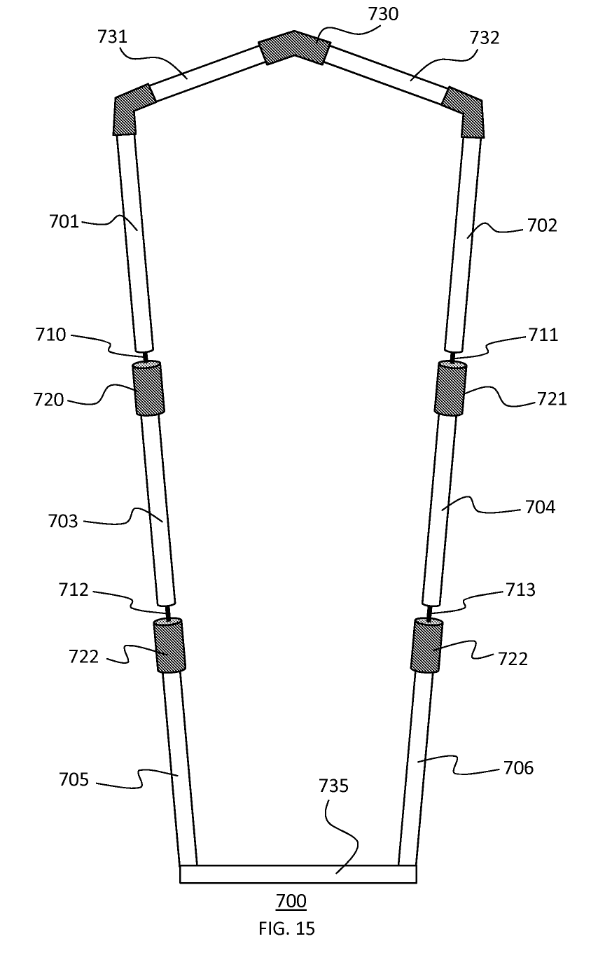

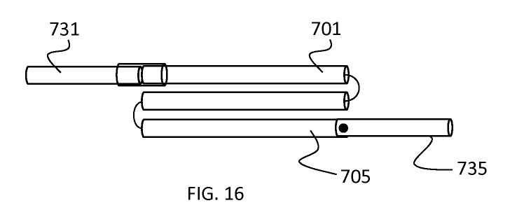

An alternate embodiment of the fabric fan of 500 is a foldable pole structure made from segmented and connected tent poles. Turning to FIG. 15, a foldable fan blade has a peripheral structure comprising a base rib 735, longitudinal pole sections 701-706 which extend from opposite sides of the base rib 735. Top ribs 731, 732 are coupled together by a ferrule 730 at the apex of the structure 700. The pole sections are connected together by elastic cords or springs, 710-713. The cords or springs stretch to allow the sections of the poles to be bent on top of one another to reduce the size of the blade for shipping. See FIG. 16. Other ferrules 720-723 connect the longitudinal poles together.

Fabric (not shown) in the form of a sleeve covers the structure 700. During assembly, the top ribs 731, 732 are not in the ferrule 730 to permit the assembler to slip the fabric sleeve over the rods. Once the fabric is installed over the structure 700, the top ribs 731, 732 are manipulated to fit into the top ferrule 730. on to the rods, the top ribs are inserted into the ferrule at the apex of the structure. The fabric comes under tension. The fabric may be elastic or at least flexible to that it folds with the folding tent poles. The fabric has elastic straps that connect to the boss to maintain tension in the fabric. In use, a fan boss (not shown) is attached to the lower rib 735 and poles 705, 706.

It should be noted that while the fan blades of the above embodiments are shown with particular shapes, the configuration of the fan blade when assembled can take on various shapes to achieve a design criteria. Thus the fan blade can look rectangular, triangular, 3 dimensional (i.e. having a plurality of levels on one blade—similar to a “box kite”), or curvilinear in appearance, but it is not limited to these only.

The invention provides a method of providing a fan blade to an end user or consumer. In the method, the fan blade is provided to an end user in a compact, unassembled form, and the end user assembles the fan blade into usable form for attachment to a blade hub of a fan. The provider of the fan blade may also provide to the end user instructions on how to assemble the fan blade into the usable form.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1-20. (canceled)

21. A fan blade assembly comprising:
a fan-motor connector;
a first support member having a first end and a second end opposite the first end, the first end being coupled to the fan-motor connector;
a first extension member having a first end and a second end, the first end of the first extension member being shaped to removably couple to the second end of the first support member; and
a fan blade member that couples to and extends along the coupled first extension member and the first support member, thereby creating an air-pushing surface,
wherein the first support member and the first extension member are shippable in a non-coupled relation and assembled in a coupled relation when attached to a fan motor.

22. The fan blade assembly according to claim 21, further comprising:
an elongated coupling element coupling the first support member and the first extension member when the first end of the first extension member is not coupled to the second end of the first support member.

23. The fan blade assembly according to claim 22, wherein:
the elongated coupling element elastically biases the first support member toward the first extension member.

24. The fan blade assembly according to claim 21, further comprising:
a ferrule coupled to the second end of the first support member and shaped to engage with the first end of the first extension member.

25. The fan blade assembly according to claim 21, further comprising:
a second support member coupled to the fan-motor connector in opposing relation to the first support member.

26. The fan blade assembly according to claim 25, further comprising:
a second extension member having a first end and a second end, the first end of the second extension member being shaped to removably couple to the second support member.

27. The fan blade assembly according to claim 26, further comprising:
a cross member coupling the second end of the first extension member to the second end of the second extension member.

28. The fan blade assembly according to claim 1, wherein:
the first support member and the first extension member telescopically slide relative to one another.

29. A method of installing a fan blade, the method comprising:
providing:
a fan-motor connector;
a first support member having a first end and a second end opposite the first end, the first end being coupled to the fan-motor connector; and
a first extension member having a first end and a second end, the first end of the first extension member being shaped to removably couple to the second end of the first support member;
coupling the first extension member to the first support member; and
at least partially covering the coupled first extension member and the first support member with a fan blade member to create an air-pushing surface.

30. The method according to claim 29, further comprising:
coupling the fan-motor connector to a fan motor.

31. The method according to claim 30, wherein:
the coupling of the fan-motor connector to the fan motor is by a quick coupler.

32. The method according to claim 29, wherein:
coupling an elongated coupling element to the first support member and the first extension member.

33. The method according to claim 32, wherein:
the elongated coupling element elastically biases the first support member toward the first extension member.

34. The method according to claim 29, further comprising:
a ferrule coupled to the second end of the first support member and shaped to engage with the first end of the first extension member.

35. The method according to claim 29, further comprising:
coupling a second support member to the fan-motor connector in opposing relation to the first support member: and
coupling a second extension member to the second support member, the second extension member being in opposing relation to the first support member.

36. The method according to claim 35, further comprising:
coupling a cross member to the first extension member and the second extension member.

37. The method according to claim 29, wherein:
the first support member and the first extension member telescopically slide relative to one another.

38. The method according to claim 29, wherein:
the coupling the first extension member ₜo the first support member is placing the first extension member in linear alignment with the first support member.

39. A fan blade assembly comprising:
a base rib;
a first pole having a first end and a second end opposite the first end, the first end being coupled to the base rib;
a second pole having a first end and a second end opposite the first end, the first end being coupled to the base rib in opposing relation to the first pole;
a third pole having a first end and a second end, the first end of the third pole being shaped to removably couple to the second end of the first pole;
a fourth pole having a first end and a second end, the first end of the fourth pole being shaped to removably couple to the second end of the second pole;
at least one top rib disposed between the second end of the third pole and the second end of the fourth pole;
an elastic cord coupling the first pole, the second pole, the third pole, the fourth pole and the at least one top rib; and
a fan blade member that at couples to the first pole, the second pole, the third pole, the fourth pole and the at least one top rib when the first pole, the second pole, the third pole, the fourth pole and the at least one top rib are directly coupled to each other, thereby creating an air-pushing surface.

40. The fan blade assembly according to claim 40, wherein:
the elastic cord is sized to maintain an elastic tension between the first pole, the second pole, the third pole, the fourth pole and the at least one top rib when the first pole, the second pole, the third pole, the fourth pole and the at least one top rib are not directly coupled to one another.
